(19) United States
(12) Patent Application Publication
(10) Pub. No.: US 2011/0120904 A1
(43) Pub. Date: May 26, 2011

(54) HOME PHARMACY KITS

(76) Inventor: Chad Harrison, Tulsa, OK (US)

(21) Appl. No.: 13/015,778

(22) Filed: Jan. 28, 2011

Related U.S. Application Data
(62) Division of application No. 12/213,508, filed on Jun. 20, 2008.
Application No. 12/213,508 is a continuation-in-part of application No. 12/046,900, filed on Mar. 12, 2008, now abandoned.
(60) Provisional application No. 60/906,414, filed on Mar. 12, 2007.

(51) Int. Cl. A61J 1/03; B65D 85/00; B65D 1/09

(52) U.S. Cl. 206/528; 206/459.5

(57) ABSTRACT

A package set is provided. The package set includes a holder; a container removably coupled to the holder; and a correlator including at least one container label coupled to the container and at least one holder label coupled to the holder, each container label and each holder label includes a description portion and an indicator, the indicator of the holder label is substantially identical to the indicator of the container label to facilitate matching at least one container to at least one holder.

### CROSS-REFERENCE TO RELATED APPLICATIONS

This application claims priority to U.S. patent application Ser. No. 12/046,900, filed Mar. 12, 2008, the entire contents of which is hereby incorporated by reference.

### BACKGROUND OF THE INVENTION

Sources indicate that Americans spend over $500 million annually on over-the-counter products to obtain relief from the symptoms associated with the common cold. At least one market research company reports that over 1400 over-the-counter cough, cold, flu and allergy products are available on the market. The multitude of cough, cold, flu and allergy products have resulted in a confusing situation for the consumer. At least one cause of this confusion is the large number of products and brands. At least one other cause of this confusion is that most cough, cold, flu and allergy products contain multiple pharmaceutical ingredients that treat more than one symptom. An additional cause of confusion is that several of the pharmaceutical ingredients in cold, cough, flu and allergy products are not recommended for consumers that have certain conditions, such as high blood pressure or diabetes or who are pregnant.

At least some consumers may not be receiving appropriate symptomatic therapy from known over-the-counter products that contain more than one pharmaceutical ingredient. At least one reason for this is that the consumer's selection of a product may be based on factors such as product marketing, lay opinion and/or guess work.

### BRIEF DESCRIPTION OF THE INVENTION

In one exemplary embodiment, a package set is provided. The package set includes a holder; a container removably coupled to the holder; and a correlator including at least one container label coupled to the container and at least one holder label coupled to the holder, each container label and each holder label includes a description portion and an indicator, the indicator of the holder label is substantially identical to the indicator of the container label to facilitate matching at least one container to at least one holder.

In another exemplary embodiment, a medication system is provided. The medication system includes a plurality of holders; a plurality of containers removably coupled to at least one holder; a plurality of active ingredient medications, at least one active ingredient medication is coupled within at least one container; and a correlator including at least one container label coupled to each container and at least one holder label coupled to each holder, each container label and each holder label includes a description portion and an indicator, the indicator of the holder label is substantially identical to the indicator of the container label to facilitate matching at least one container to at least one holder.

In yet another exemplary embodiment, a method of correlating at least one active ingredient medication with at least one symptom is provided. The method includes providing a plurality of containers that include at least one first label coupled thereto, each first label includes a first indicator; coupling at least one container to a holder that includes at least one second labeled coupled thereto, each second label includes a second indicator; coupling at least one active ingredient medication to at least one container; correlating the holder and second indicator to at least one container and first indicator, wherein the first indicator is substantially identical to the second indicator; and creating a concoction using the at least one active ingredient medication coupled within the at least one container.

### BRIEF DESCRIPTION OF THE DRAWINGS

Advantages of embodiments of the present invention will be apparent from the following detailed description of the exemplary embodiments. The following detailed description should be considered in conjunction with the accompanying figures in which:

FIG. 1 is a perspective view of a medication kit;

FIG. 2 is a perspective view of an alternate embodiment of a medication kit;

FIG. 3 is a perspective view of another alternative embodiment of a medication kit; and

FIG. 4 is a reference chart.

### DETAILED DESCRIPTION OF THE INVENTION

Aspects of the present invention are disclosed in the following description and related figures directed to specific embodiments of the invention. Those skilled in the art will recognize that alternate embodiments may be devised without departing from the spirit or the scope of the claims. Additionally, well-known elements of exemplary embodiments of the invention will not be described in detail or will be omitted so as not to obscure the relevant details of the invention.

As used herein, the word “exemplary” means “serving as an example, instance or illustration.” The embodiments described herein are not limiting, but rather are exemplary only. It should be understood that the described embodiment are not necessarily to be construed as preferred or advantageous over other embodiments. Moreover, the terms “embodiments of the invention”, “embodiments” or “invention” do not require that all embodiments of the invention include the discussed feature, advantage or mode of operation.

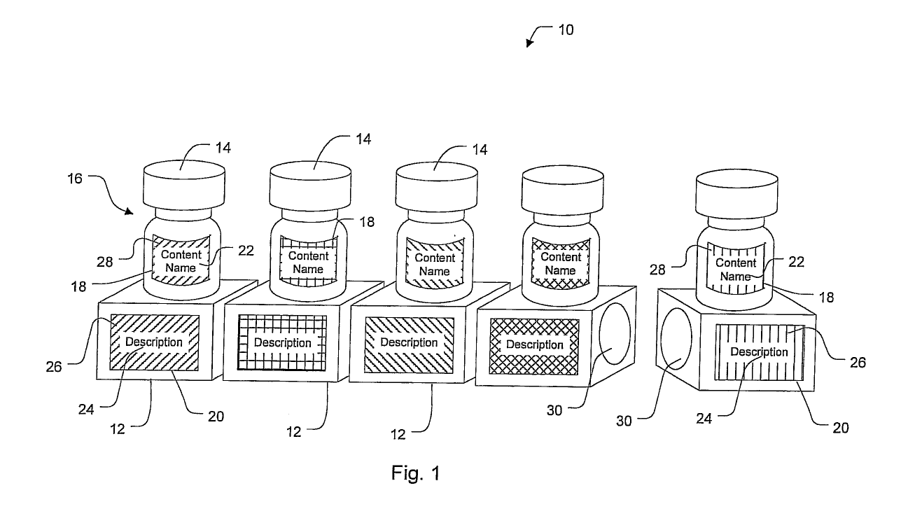

FIG. 1 is a perspective view of a medication kit 10 that includes a plurality of holders 12 and a plurality of containers 14. At least one container 14 is removably coupled to each holder 12. In the exemplary embodiment, each container 14 may include a bottle. Alternatively, containers 14 may include, but not limited to, syringes, vials, blister packs, bags and/or any other type of container that enables kit 10 to function as described herein. In the exemplary embodiment, each holder 12 may be a box that includes a substantially square cross-sectional shape. Alternatively, holders 12 may be an organizer and/or any type of container and may include any cross-sectional shape that enables kit 10 to function as described herein. Moreover, holders 12 may be made of wood, plastic, cardboard and/or any other type of material that enables kit 10 to function as described herein.

Medication kit 10 may also include a correlator 16 that may include a plurality of first labels 18 and a plurality of second labels 20. Each first label 18 may be coupled to each container 14 and each second label 20 may be coupled to each holder 12. Moreover, each first label 18 may include, but not limited to, a name 22 of the contents and/or the dosing information of the contents contained within each respective container 14. Moreover, each second label 20 may include a description 24 associated with at least one of the contents of at least one of the containers 14. In one embodiment, description 24 may include, but not limited to, the symptoms a user may have and/or the effects that the container contents may have on the user.

First and second labels 18 and 20 may include a first and second indicator 26 and 28, respectively. Specifically, in the exemplary embodiment, each first and second indicators 26 and 28 may be a unique pattern. In an alternative embodiment, each first and second indicators 26 and 28 may include, but not limited to, a color, a symbol, a character, a word, a texture, a watermark and/or any other distinguishing indicator that enables kit 10 to function as described herein. Correlator 16, and more specifically, first and second indicators 26 and 28 facilitate matching at least one second label 20 coupled to holder 12 with at least one first label 18 coupled to at least one container 14, as described in more detail below.

Moreover, each holder 12 may include at least one attachment mechanism 30 such that each holder 12 may be coupled to at least one other holder 12. In the exemplary embodiment, attachment mechanism 30 may include a magnet. Alternatively, attachment mechanism 30 may include, but not limited to, magnets, hook and loop fasteners, tongue and groove surfaces and/or any other coupling means that enables kit 10 to function as described herein. As a result, attachment mechanism 30 enables the user to customize kit 10 to the user's preferences.

In the exemplary embodiment, each container 14 may include an amount of medication (not shown) coupled therein. Specifically, the medication may include, but not limited to, an active ingredient medication. Alternatively, each container 14 may include other over-the-counter (“OTC”) products such as, but not limited to, vitamins, supplements, diets aids, creams, lotions, ointments, supplements and/or any other medical and/or toiletry component. In the exemplary embodiment, kit 10 includes five containers 14 that are associated with specific active ingredient medication categories. Specifically, the five categories may include, but not limited to, an expectorant, a pain reliever, a decongestant, an antitussive and/or an antihistamine. In an alternative embodiment, kit 10 may include any number of and any type of active ingredient medication categories.

The expectorant may include an active ingredient of guaifenesin. Alternatively, the expectorant may include any type of active ingredient that facilitates reducing chest congestion within a person. The pain reliever may include active ingredients including, but not limited to, acetaminophen, ibuprofen, naproxen and/or aspirin. Alternatively, the pain reliever may include any type of active ingredient that facilitates reducing ailments such as, but not limited to, headaches, muscle aches, arthritis, backache, toothaches fever and/or sore throat. The decongestant may include any type of active ingredient including, but not limited to, phenylephrine and/or pseudoephedrine. Alternatively, the decongestant may include any type of active ingredient that facilitates reducing sinus congestion. The antitussive may include an active ingredient of dextromethorphan. Alternatively, the antitussive may include any active ingredient that facilitates suppressing a cough. The antihistamine may include active ingredients including, but not limited to, chlorpheniramine, diphenhydramine, loratadine, doxylamine, bropheniramine and/or clemastine. Alternatively, the antihistamine may include any active ingredient that facilitates relieving ailments such as, but not limited to, a runny nose, itching, watery eyes, hives and/or rashes.

In the exemplary embodiment, each container 14 may include active ingredients from drug brands and/or generic drugs that have been approved by the U.S. Food and Drug Administration (“FDA”). Moreover, each container 14 may include active ingredients in dose forms including, but not limited to, tablets, capsules, gelcaps, geltabs, liquids, effervescent tablets, powder packets, chewable tablets, dissolving tablets, thin strips and/or any other dose form that enables kit 10 to function as described herein. In one embodiment, each form of the active ingredient dose may include an indicator, such as but not limited to color, that is substantially identical to the first indicator 26 to which the active ingredient dose is associated. In another embodiment, kit 10 may include flavor packets that include a plurality of flavors that may be added to the active ingredient medications to facilitate producing a flavor that may be pleasing to the user. In the exemplary embodiment, effervescent tablets and powder packets may be designed and packaged such that a plurality of active ingredients may be combined and dissolved together to form a unique concoction. Such a concoction may be customized to address an individual's unique symptoms, as described in more detail below. As a result, each concoction may include the specific active ingredients that treat the user's symptoms.

The dosage strengths, dosage forms and dosage regimens may follow FDA approved guidelines for each active ingredient medication such as, but not limited to, label information, warnings and package requirements. In one embodiment, each container 14 may contain between about 20 to about 100 doses such as, but not limited to, pills, tablets and/or capsules. Alternatively, each container 14 may contain any number of doses that enables kit 10 to function as described herein. In another embodiment, each container 14 may contain between about 30 ml to about 120 ml of liquid medication. Alternatively, each container 14 may contain any amount of liquid that enables kit 10 to function as described herein. In yet another embodiment, each container 14 may be disposable and/or refillable.

In the exemplary embodiment, kit 10 may be customized be the user according to the active ingredient medications associated with the user's symptoms. As a result, the user may group a plurality of holders 12 and containers 14 together using attachment mechanism 30. Specifically, attachment mechanism 30 facilitates coupling at least one holder 12 to at least one other holder 12 to enable the user to customize what specific active ingredients are included in kit 10. In one embodiment, holders 12 may be coupled together in a side-by-side arrangement and/or a back-to-back arrangement. In another embodiment, holders 12 may be coupled together in any arrangement that enables kit 10 to function as described herein.

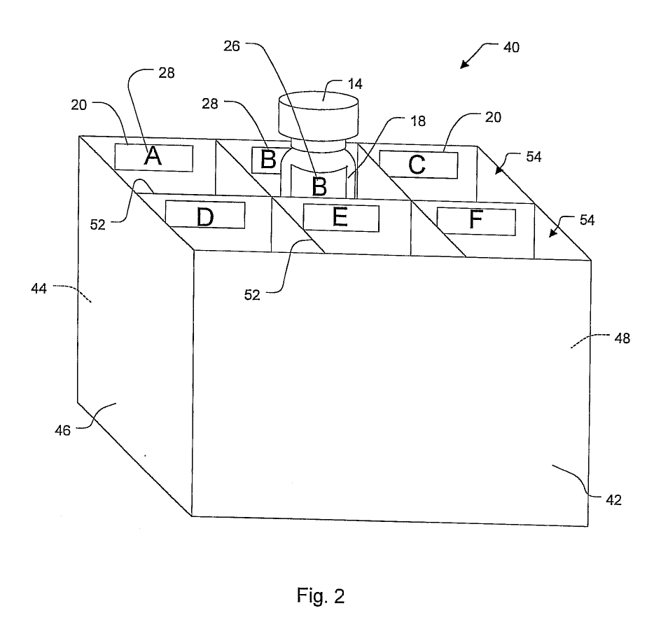

FIG. 2 is a perspective view of an alternative holder 40 that may be used with kit 10. Components of holder 40 are substantially similar to components of holder 12, and like components are identified with like reference numerals. In the exemplary embodiment, holder 40 may be an organizer that is boxed-shape and includes a front wall 42, a rear wall 44, a first sidewall 46 and a second sidewall 48. Moreover, holder 40 may include an open upper portion 50. Alternatively, holder 40 may be any shape and any number of walls that enable kit 10 to function as described herein. In yet another embodiment, holder 40 may include a closed upper portion 50. Holder 40 may also include a cavity defined therein, and a plurality of internal dividers 52 positioned within the cavity. Holder 40 may include at least one divider that extends between first sidewall 46 and second sidewall 48. Moreover, holder 40 may include at least one divider 52 that extends between front wall 42 and rear wall 44. Moreover, the plurality of dividers 52 may be customizable. In one embodiment, at least one divider 52 may interlock with at least one other divider 52. In another embodiment, each divider may be made out of wood, plastic, cardboard and/or any other type of material that enables kit 10 to function as described herein. As a result, dividers 52 may define a plurality of container compartments 54 within the cavity of holder 40.

Each container compartment 54 may include at least one active ingredient coupled therein. Specifically, in the exemplary embodiment, at least one container 14 is at least partially inserted within container compartment 54 such that container 14 is removably coupled to holder 40. In one embodiment, container 14 may be a bottle. In an alternative embodiment, container 14 may include, but not limited to, syringes, vials, blister packs, bags and/or any other type of container that enables kit 10 to fimction as described herein. In yet another alternative embodiment, each container compartment 54 may contain active ingredients in a loose and/or open form such that each compartment represents a container.

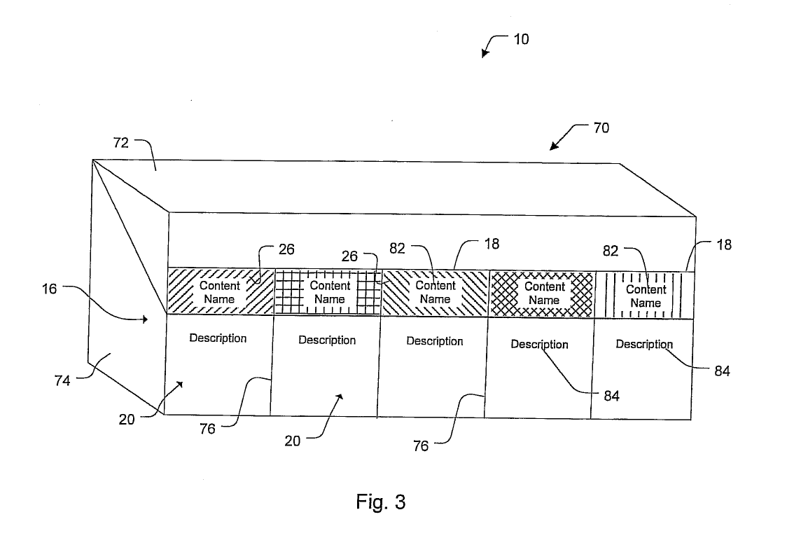

Moreover, each holder 40 may also include a correlator (not shown) that is substantially similar to correlator 16 shown in FIGS. 1 and 3. The correlator may include a plurality of first labels 18 and a plurality of second labels 20. Each first label 18 may be coupled to each container 14 and each second label 20 may be coupled to each compartment 54, and more specifically, at least one divider 52 positioned adjacent compartment 54. Moreover, each first label 18 may include a name (not shown) of the contents and/or dosing information of the contents contained within the respective container compartment 54. Furthermore, each second label 20 may include a description (not shown) associated with the contents of each respective container compartment 54. In one embodiment, the description may include the user's symptoms and/or the effects that the container contents may have on the user.

First and second labels 18 and 20 may include a first and second indicator 26 and 28, respectively. Specifically, in the exemplary embodiment, each first and second indicators 26 and 28 may be a unique character. In an alternative embodiment, each first and second indicators 26 and 28 may include, but not limited to, a color, a symbol, a pattern, a word, a texture, a watermark and/or any other distinguishing indicator that enables kit 10 to function as described herein. Correlator 16, and more specifically, first and second indicators 26 and 28 facilitate matching at least one second label 20 coupled to holder 40 with at least one first label 18 coupled to at least one container 14, as described in more detail below.

FIG. 3 is a perspective view of an alternative holder 70 that may be used with kit 10. Components of holder 70 are substantially similar to components of holder 12, and like components are identified with like reference numerals. In the exemplary embodiment, holder 70 may be box-shaped and include an upper lid portion 72 and a bottom body portion 74. Alternatively, holder 70 may be any shape that enables kit 10 to function as described herein. Holder 70 may also include a cavity (not shown) defined therein, and a plurality of internal dividers (not shown) positioned substantially adjacent a plurality of delineators 76 positioned on a front face portion 78. The plurality of dividers may define a plurality of containers (not shown) and/or a plurality of container compartments (not shown) that may house at least one active ingredient therein.

Moreover, each holder 70 may also include a correlator 16 that may include a plurality of first labels (not shown) and a plurality of second labels 20. Each of the first labels may be coupled to a container (not shown) that is coupled within holder 70. Each second label 20 may be coupled to upper lid portion 72 of holder 70. At least one second label 20 coupled to front face portion 78 substantially adjacent a container compartment. Further, each second label 20 may include a name 82 of the contents and/or the dosing information of the contents contained within the respective container compartment. Moreover, each lower body portion 74 may include a description portion 84 that is positioned adjacent each corresponding second label 20 and associated with the contents of the respective container compartment. In one embodiment, description 84 may include the user's symptoms and/or the effects that the container contents may have on the user.

The first label and second label 20 may include a first indicator (not shown) and a second indicator 28. Specifically, in the exemplary embodiment, each first indicator and second indicator 28 may be a unique pattern. In an alternative embodiment, each first indicator and second indicator 28 may include, but not limited to, a color, a symbol, a character, a word, a texture, a watermark and/or any other distinguishing indicator that enables kit 10 to function as described herein. Correlator 16, and more specifically, first indicator and second indicator 28 facilitate matching at least one second label 20 coupled to holder 70 with at least one of the first labels coupled to at least one container that is coupled within holder 70, as described in more detail below.

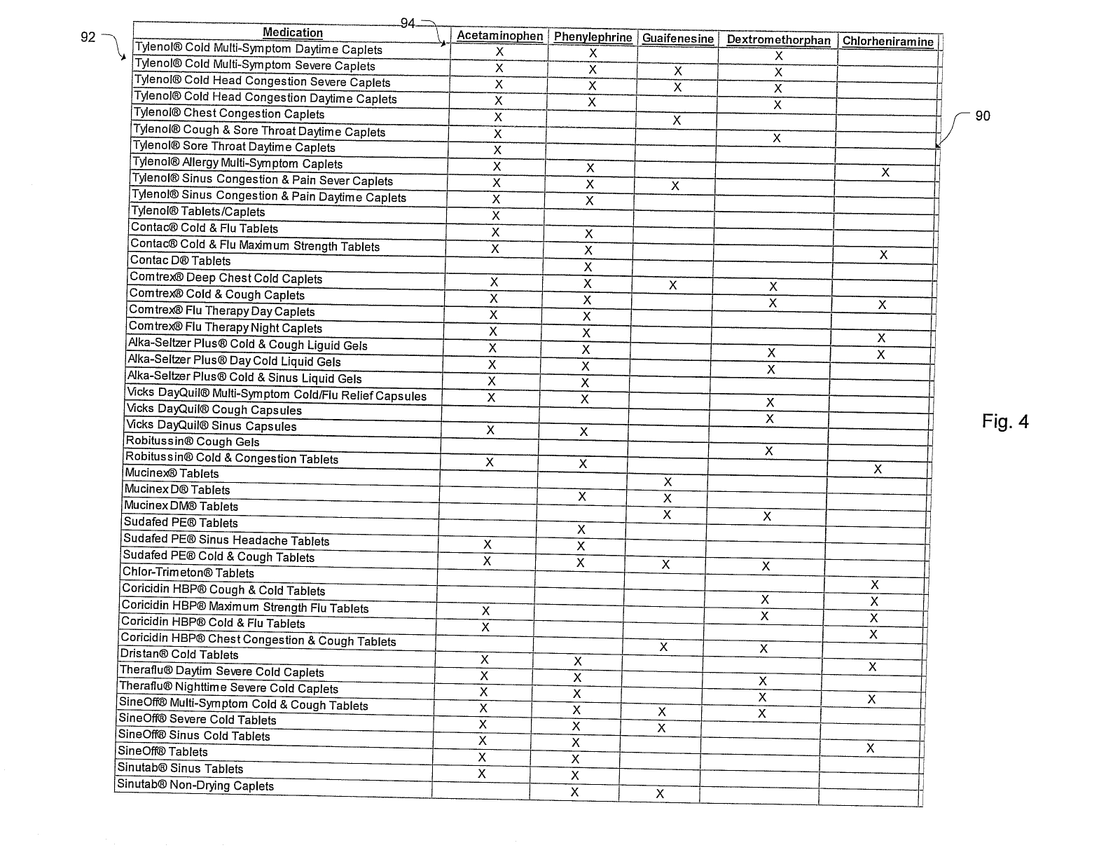

FIG. 4 is a reference chart 90 that includes a plurality of exemplary OTC products 92 and a plurality of exemplary active ingredient medications 94. In the exemplary embodiment, chart 90 facilitates identifying at least one active ingredient medication 94 included within the listed OTC products 92. As a result, chart 90 enables the user to identify at least one OTC product 92 that includes the active ingredient medication 94 the user requires based on the user's symptoms. Moreover, chart 90 enables the user to identify active ingredient medication 94 is at least one OTC product 92 such that the user may create their own concoction of active ingredient medications 94 using kit 10.

In an alternative embodiment, kit 10 may include active ingredient medication in liquid form for child dosing therapy. In the exemplary embodiment, kit 10 may include a syringe measuring device (not shown) that facilitates accurately measuring and dosing active ingredients from containers 14. The syringe may be sized to facilitate measuring an amount of liquid active ingredient medications. In one embodiment, the syringe may be sized to facilitate measuring a plurality of liquid active ingredient medications that are combined together.

In a second alternative embodiment, kit 10 may include single active ingredients that are safe for women who are pregnant. In one embodiment, safe active ingredient medications may be defined as any drug that is rated by the FDA as being therapeutically safe for women who are pregnant. In another embodiment, kit 10 may include active ingredients such as, but not limited to, acetaminophen and/or chlorpheniramine. As a result, kit 10 facilitates offering symptomatic therapy for pregnant women who are concerned about potentially harmful active medication ingredients as classified by the FDA. Moreover, kit 10 may also facilitate educating consumers who may be unfamiliar with active ingredients of medications and their FDA classifications regarding pregnancy, such that the consumers may obtain safe cough and cold symptomatic therapy.

In a third alternative embodiment, kit 10 may include single active ingredient medications that are safe for consumers diagnosed with high blood pressure. In one embodiment, safe active ingredient medications may be defined as any drug that is approved by the American Heart Association (“AHA”). In one embodiment, kit 10 may include active ingredient medications such as, but not limited to, acetaminophen, chlorpheniramine, dextromethorphan and/or guaifenensin. As a result, kit 10 facilitates offering symptomatic therapy for consumers with high blood pressure who are concerned about potentially harmful active ingredient medications as classified by the AHA. Moreover, kit 10 may also facilitate education consumers who may be unfamiliar with active ingredient of medications and their AHA classifications regarding high blood pressure, such that the consumers may obtain safe cough and cold symptomatic therapy.

In a fourth alternative embodiment, kit 10 may include single active ingredient medications that may be used in gastrointestinal related symptomatic therapy. In the exemplary embodiment, kit 10 facilitate reducing consumer confusion regarding the plurality of OTC gastrointestinal medications that include a plurality of single active ingredient medications. Moreover, kit 10 may include, but not limited to, an acid reducer, a stool softener, an anti-diarrheal, an anti-gas, a laxative and/or an antacid. Alternatively, kit 10 may include any type of gastrointestinal medications that enable kit 10 to function as described herein.

In the exemplary embodiment, the acid reducer may include active ingredients such as, but not limited to, ranitidine, cimetidine and/or famotadine. Alternatively, the acid reducer may include any type of active ingredient that facilitates treating acid reflux. The stool softener may include active ingredients including, but not limited to, docusate sodium and/or docusate calcium. Alternatively, the stool softener may include any type of active ingredient that facilitates treating constipation. The anti-diarrheal may include an active ingredient of loperamide. Alternatively, the anti-diarrheal may include any type of active ingredient that facilitates treating diarrhea. The anti-gas may include an active ingredient of simethicone. Alternatively, the anti-gas may include any active ingredient that facilitates reducing gas pressure. The laxative may include active ingredients including, but not limited to, bisacodyl and/or senna. Alternatively, the laxative may include any active ingredient that facilitates treating constipation. The antacid may include active ingredient including, but not limited to, calcium carbonate and/or magnesium hydroxide. Alternatively, the antacid may include any active ingredient that facilitates treating heartburn.

In a fifth alternative embodiment, kit 10 may include smaller containers 14 and smaller holders 12 such that kit 10 may be portable. For example, kit 10 may include, but not limited to, active ingredient medications in oral form, “thin strip” form and/or any other form that enables kit 10 to be portable.

The following description of the operation of kit 10 generally applies to each of the above-described embodiments. During operation, each container 14 may include at least one first label 18 coupled thereto and at least one active ingredient medication coupled within each container 14. Moreover, each active ingredient may be categorized into a specific category. For example, in one embodiment, active ingredients such as, but not limited to, acetaminophen, ibuprofen and aspirin may be categorized as “pain relievers.” Each active ingredient category may be associated with a first indicator 26 on first label 18. As a result, each first label 18 that is coupled to at least one container 14 may include the active ingredient name, the active ingredient category and/or first indicator 26 that is associated with the active ingredient category contained therein. Further, each holder 12 includes at least one second label 20 coupled thereto. Specifically, in the exemplary embodiment, each second label 20 may include a description that may describe the user's symptoms that may be treated by active ingredient medications within a specific category. As a result, each second label 20 that describes symptoms that may be treated by active ingredient medications within a specific category may include second indicator 28 that is substantially identical to first indicator 26 of each container 14, which includes active ingredient medications associated with that category coupled therein. As such, first and second indicators 26 and 28 facilitate matching the user's symptoms with the appropriate active ingredient category, and more specifically, the appropriate active ingredient medication. In the exemplary embodiment, first and second indicators 26 and 28 may be patters and/or characters displayed on first and second labels 18 and 20, respectively.

Moreover, during operation, the user identifies their symptom on at least one second label coupled to holder 12. The user then matches second indicator 28 of second label 20 with first indicator 26 of first label 18 on at least one container 14. The user then follows the dosing instructions provided on first label 18 and creates a individual concoction that facilitates treating the user's specific symptoms.

Further, the user may refer to chart 90 and identify which OTC product 92 includes the active ingredient medications 94 the user's requires based on the user's symptoms. The user may then purchase and ingest that specific OTC product 92 to treat the user's symptoms. Alternatively, the user may create a specific concoction, as described above, such that the user is not required to purchase the OTC product 92.

As described in the above embodiments, kit 10 enables consumers to easily determine and select specific active ingredient medications for treating the symptoms they may have. As a result, kit 10 enables the user to take the specific active ingredient medication they require based on their symptoms. As such, kit 10 facilitates preventing the consumers from taking any active ingredient medications that they do not require compared to OTC products. Moreover, kit 10 facilitate assisting users who may be currently combining a plurality of OTC drug products without proper instruction. Moreover, kit 10 facilitates saving the user time and money by reducing the need of the user to purchase multiple OTC products to treat the user's symptoms.

The foregoing description and accompanying figures illustrate the principles, preferred embodiments and modes of operation of the invention. However, the invention should not be construed as being limited to the particular embodiments discussed above. Additional variations of the embodiments discussed above will be appreciated by those skilled in the art.

Therefore, the above-described embodiments should be regarded as illustrative rather than restrictive. Accordingly, it should be appreciated that variations to those embodiments can be made by those skilled in the art without departing from the scope of the invention as defined by the following claims.

1-16. (canceled)

17. A method of correlating at least one active ingredient medication with at least one symptom, said method comprises:
providing a plurality of containers that include at least one first label coupled thereto, each first label includes a first indicator;
coupling at least one container to a holder that includes at least one second labeled coupled thereto, each second label includes a second indicator;
coupling at least one active ingredient medication to at least one container;
correlating the holder and second indicator to at least one container and first indicator, wherein the first indicator is substantially identical to the second indicator; and
creating a concoction using the at least one active ingredient medication coupled within the at least one container.

18. A method in accordance with claim 17 further comprising:
categorizing each active ingredient medication into a plurality of categories;
assigning each category to at least one first indicator of the first label; and
assigning each description of each category to at least one second indicator of the second label that is substantially identical to the first indicator of the first label.

19. A method in accordance with claim 18 further comprising:
matching a symptom of a user with a description of the second label that includes a second indicator; and
locating at least one container that includes a first label that includes a first indicator that is substantially identical to the second indicator of the second label.

20. A method in accordance with claim 17 further comprising:
identifying at least one over-the-counter product on a reference chart;
determining the active ingredient medications included within the at least one over-the-counter product; and
creating a concoction that includes active ingredient medications that are substantially identical to the active ingredient medications included within the at least one over-the-counter product.
